(19) United States
(12) Patent Application Publication
(10) Pub. No.: US 2026/0332467 A1
(43) Pub. Date: Oct. 22, 2026

(54) VARIABLE CYCLIC PREFIX DURATION

(71) Applicant: Lenovo (United States) Inc., Morrisville, NC (US)

(72) Inventors: Sher Ali Cheema, Ilmenau (DE); Seyedomid Taghizadeh Motlagh, Oberursel (DE); Ali Ramadan Ali, Kraiburg (DE)

(73) Assignee: Lenovo (United States) Inc., Morrisville, NC (US)

(21) Appl. No.: 19/177,191

(22) Filed: Apr. 11, 2025

(51) Int. Cl. H04L 27/26; H04W 24/10

(52) U.S. Cl. CPC H04L 27/2678; H04L 27/26526; H04W 24/10

(57) ABSTRACT

Various aspects of the present disclosure relate to variable cyclic prefix (CP) duration. A user equipment (UE) receives an indication of one or more CP durations for one or more symbols in a slot of a frame, where the frame has a fixed duration, and where a number of symbols in the frame are independent of the one or more CP durations. The UE transmits the frame, where the frame includes, in a CP duration for each symbol a CP comprising at least one known sequence.

### TECHNICAL FIELD

The present disclosure relates to wireless communications, and more specifically to variable cyclic prefix (CP) duration.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive an indication of one or more CP durations for one or more symbols in a slot of a frame, where the frame has a fixed duration, and where a number of symbols in the frame are independent of the one or more CP durations; and transmit the frame, where the frame includes, in a CP duration for each symbol a CP including at least one known sequence.

A processor (e.g., a standalone processor chipset, or a component of a UE) for wireless communication is described. The processor may be configured to, capable of, or operable to perform one or more operations as described herein. For example, the processor may be configured to, capable of, or operable to receive an indication of one or more CP durations for one or more symbols in a slot of a frame, where the frame has a fixed duration, and where a number of symbols in the frame are independent of the one or more CP durations; and transmit the frame, where the frame includes, in a CP duration for each symbol a CP including at least one known sequence.

A method performed or performable by a UE for wireless communication is described. The method may include receiving an indication of one or more CP durations for one or more symbols in a slot of a frame, where the frame has a fixed duration, and where a number of symbols in the frame are independent of the one or more CP durations; and transmitting the frame, where the frame includes, in a CP duration for each symbol a CP including at least one known sequence.

In some implementations of the UE, the processor, and the method described herein, each symbol in the frame comprises an orthogonal frequency-division multiplexing (OFDM) symbol, and where for each OFDM symbol, the CP duration comprises part of an inverse Fourier transform (IFFT) duration of the OFDM symbol. In some implementations of the UE, processor, and method described herein, the UE, processor, and method may further be configured to, capable of, performed, performable, or operable to use a same CP duration for all of the symbols in the slot of the frame.

In some implementations of the UE, the processor, and the method described herein, each symbol in the frame comprises an OFDM symbol, and where the indication comprises a configuration that includes, for each OFDM symbol, an index for a code generator matrix that generates zeroes corresponding to the CP duration at an IFFT output within a duration of the OFDM symbol. In some implementations of the UE, the processor, and the method described herein, a look-up table defines a one-to-one relationship of each of multiple code generator matrices to a CP duration or a known sequence length for a fast Fourier transform (FFT) length.

In some implementations of the UE, the processor, and the method described herein, the configuration further includes an index that identifies a code generator matrix of the multiple code generator matrices and the known sequence length from the look-up table. In some implementations of the UE, processor, and method described herein, the UE, processor, and method may further be configured to, capable of, performed, performable, or operable to receive a configuration that indicates to use different CP durations within a slot or across slots, where the configuration includes a set of indices for code generator matrices for each of the different CP durations; apply a same code generator matrix for each symbol having a same CP duration; generate the at least one known sequence that has a length corresponding to a largest CP duration; and use the generated at least one known sequence inside each of the different CP durations.

In some implementations of the UE, processor, and method described herein, each symbol in the frame comprises an orthogonal OFDM symbol, and the UE, processor, and method may further be configured to, capable of, performed, performable, or operable to receive an indication to use the at least one known sequence in the one or more CP durations for at least one of the OFDM symbols in a slot of a frame, where the at least one known sequence includes a first known sequence at an end of the OFDM symbol and a second known sequence at a start of the OFDM symbol, where the first known sequence and the second known sequence have a same length, where the first known sequence is part of an IFFT interval, and where the second known sequence is added as an additional CP duration, and where the frame includes at least one symbol with the second known sequence added at the start of the OFDM symbol as a CP and the first known sequence added at the end of a duration of the OFDM symbol. In some implementations of the UE, processor, and method described herein, the first known sequence and the second known sequence are a same sequence with a same length.

In some implementations of the UE, processor, and method described herein, the UE, processor, and method may further be configured to, capable of, performed, performable, or operable to receive an indication of a position of symbols in the slot with second known sequence added at the start as the CP and the first known sequence added at the end of the duration of the OFDM symbol. In some implementations of the UE, processor, and method described herein, the UE, processor, and method may further be configured to, capable of, performed, performable, or operable to use an identity matrix as a code generator matrix for symbols in the slot with random data as CP.

In some implementations of the UE, processor, and method described herein, the UE, processor, and method may further be configured to, capable of, performed, performable, or operable to receive a reporting configuration that includes an indication of a selection of a CP duration out of a set of configured CP durations based at least in part on propagating channel conditions; and transmit a report that includes at least an indication of a length of the CP duration. In some implementations of the UE, processor, and method described herein, the report comprises a channel state information (CSI) report.

In some implementations of the UE, processor, and method described herein, the report includes a field that indicates a length of the at least one known sequence. In some implementations of the UE, processor, and method described herein, the report includes an indication of an index derived from mapping of channel quality indicator (CQI) and the one or more CP durations to select a length of the at least one known sequence.

An NE (e.g., a base station) for wireless communication is described. The NE may be configured to, capable of, or operable to perform one or more operations as described herein. For example, the NE may be configured to, capable of, or operable to transmit an indication of one or more CP durations for one or more symbols in a slot of a frame, where the frame has a fixed duration, and where a number of symbols in the frame are independent of the one or more CP durations; and receive the frame, where the frame includes, in a CP duration for each symbol a CP including at least one known sequence.

A processor (e.g., a standalone processor chipset, or a component of an NE (e.g., a base station)) for wireless communication is described. The processor may be configured to, capable of, or operable to perform one or more operations as described herein. For example, the processor may be configured to, capable of, or operable to transmit an indication of one or more CP durations for one or more symbols in a slot of a frame, where the frame has a fixed duration, and where a number of symbols in the frame are independent of the one or more CP durations; and receive the frame, where the frame includes, in a CP duration for each symbol a CP including at least one known sequence.

A method performed or performable by an NE (e.g., a base station) for wireless communication is described. The method may include transmitting an indication of one or more CP durations for one or more symbols in a slot of a frame, where the frame has a fixed duration, and where a number of symbols in the frame are independent of the one or more CP durations; and receiving the frame, where the frame includes, in a CP duration for each symbol a CP including at least one known sequence.

In some implementations of the NE, the processor, and the method described herein, each symbol in the frame comprises an OFDM symbol, and where for each OFDM symbol, the CP duration comprises part of an IFFT duration of the OFDM symbol. In some implementations of the NE, the processor, and the method described herein, a same CP duration is used for all of the symbols in the slot of the frame.

In some implementations of the NE, the processor, and the method described herein, each symbol in the frame comprises an OFDM symbol, and where the indication comprises a configuration that includes, for each OFDM symbol, an index for a code generator matrix that generates zeroes corresponding to the CP duration at an IFFT output within a duration of the OFDM symbol. In some implementations of the NE, the processor, and the method described herein, a look-up table defines a one-to-one relationship of each of multiple code generator matrices to a CP duration or a known sequence length for a FFT length.

In some implementations of the NE, the processor, and the method described herein, the configuration further includes an index that identifies a code generator matrix of the multiple code generator matrices and the known sequence length from the look-up table. In some implementations of the NE, processor, and method described herein, the NE, processor, and method may further be configured to, capable of, performed, performable, or operable to transmit a configuration that indicates to use different CP durations within a slot or across slots, where the configuration includes a set of indices for code generator matrices for each of the different CP durations.

In some implementations of the NE, processor, and method described herein, each symbol in the frame comprises an OFDM symbol, and the NE, processor, and method may further be configured to, capable of, performed, performable, or operable to transmit an indication to use the at least one known sequence in the one or more CP durations for at least one of the OFDM symbols in a slot of a frame, where the at least one known sequence includes a first known sequence at an end of the OFDM symbol and a second known sequence at a start of the OFDM symbol, where the first known sequence and the second known sequence have a same length, where the first known sequence is part of an IFFT interval, and where the second known sequence is added as an additional CP duration, and where the frame includes at least one symbol with the second known sequence added at the start of the OFDM symbol as a CP and the first known sequence added at the end of a duration of the OFDM symbol. In some implementations of the NE, processor, and method described herein, the first known sequence and the second known sequence are a same sequence with a same length.

In some implementations of the NE, processor, and method described herein, the NE, processor, and method may further be configured to, capable of, performed, performable, or operable to transmit an indication of a position of symbols in the slot with second known sequence added at the start as the CP and the first known sequence added at the end of the duration of the OFDM symbol.

In some implementations of the NE, processor, and method described herein, the NE, processor, and method may further be configured to, capable of, performed, performable, or operable to transmit a reporting configuration that includes an indication of a selection of a CP duration out of a set of configured CP durations based at least in part on propagating channel conditions; and receive a report that includes at least an indication of a length of the CP duration. In some implementations of the NE, processor, and method described herein, the report comprises a CSI report.

In some implementations of the NE, processor, and method described herein, the report includes a field that indicates a length of the at least one known sequence. In some implementations of the NE, processor, and method described herein, the report includes an indication of an index derived from mapping of CQI and the one or more CP durations to select a length of the at least one known sequence.

### BRIEF DESCRIPTION OF THE DRAWINGS

FIG. 1 illustrates an example of a wireless communications system in accordance with aspects of the present disclosure.

FIG. 2 illustrates an example of wireless communication in accordance with aspects of the present disclosure.

FIG. 3 illustrates an example of an uplink-downlink (UL-DL) timing relation in accordance with aspects of the present disclosure.

FIG. 4 illustrates an example of a flexible frame structure in accordance with aspects of the present disclosure.

FIG. 5 illustrates an example of variable CP durations in accordance with aspects of the present disclosure.

FIG. 6 illustrates an example of generation of variable CP durations in accordance with aspects of the present disclosure.

FIGS. 7 and 8 illustrate examples of a legacy frame structure with a known sequence in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates a flowchart of a method performed by a UE in accordance with aspects of the present disclosure.

FIG. 13 illustrates a flowchart of a method performed by an NE in accordance with aspects of the present disclosure.

### DETAILED DESCRIPTION

In some wireless communications systems (e.g., 5G new radio (NR) wireless communications systems), a multi-carrier (e.g., CP orthogonal frequency division multiplexing (CP-OFDM)) based waveform is used for downlink (DL) as well as for uplink (UL). A single carrier (e.g., discrete Fourier transform spreading orthogonal frequency division multiplexing (DFT-s-OFDM)) can also be used for UL. The UL and DL communication between a UE and an NE is performed over a communication pathway that may be referred to as a channel (e.g., a physical channel). The wireless communications system uses a hierarchical radio frame structure in the channel in which the radio frame is divided into multiple subframes. Each subframe is divided into multiple slots and each slot includes a number of OFDM symbols.

In CP-OFDM, CP is used as guard intervals between consecutive OFDM symbols to eliminate inter-symbol interference (ISI) among these symbols. The wireless communications systems adopt a semi-flexible numerology where for each of the sub carrier spacings, the number of symbols in a slot or frame are fixed based on two defined CP durations, referred to as normal CP (NCP) and extended CP (ECP). Based on the channel conditions, only one of the CP durations is selected, thus corresponding numerology with a predefined number of symbols in the slot or frame is selected. However, having only two CP durations may be problematic for a wireless communications system because channel conditions vary for different scenarios, e.g., based on one or more of line-of-sight, non-line-of-sight, indoor communications, outdoor communications, or for non-terrestrial systems with much larger delays. This implies that a fixed number of resources are always used for NCP, even in a case when the channel conditions are very good. However, if variable CP durations based on channel condition are adopted, then the frame structure may need to be modified for each of the CP durations (e.g., the number of symbols in a slot may not fit in the predefined slot duration, e.g., may cross the slot boundary for different CP durations, as total symbol duration including the CP would change for all of the symbols in the slot), thus adding system design complexity.

Described herein are frame structures in which the numerology does not depend on CP durations but that supports different CP durations. These frame structures use known sequence OFDM, also referred to as unique word OFDM, where the CP duration is part of the OFDM symbol generation (e.g., is part of an IFFT duration). The frame structures described herein use different numerologies corresponding to different subcarrier spacings with a fixed number of symbols in a slot and may use different CP durations without defining a numerology or a frame structure for different CP durations. A known sequence (e.g., a unique word) is used in the CP duration instead of random data for one or more OFDM symbols inside the slot. The frame structure is backward compatible (e.g., with 5G NR), but uses a known sequence (e.g., a unique word) instead of a random data CP.

Accordingly, the frame structures described herein have a flexible numerology that is independent of CP durations and where the CP duration may be changed based on the channel condition for one or multiple symbols in a slot or frame. However, in this case the number of symbols in the slot or frame are the same and do not vary based on the CP duration.

Another issue with the use of CP in CP-OFDM is wasted resources, since CP is used only for cyclic convolution purposes and may not be used for any other purpose because CP is a redundant part of the data and is unknown at the receiver. In contrast, the frame structures discussed herein can use a known sequence (e.g., a unique word) in the CP duration that can effectively be used for any other purpose, such as synchronization or channel estimation.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

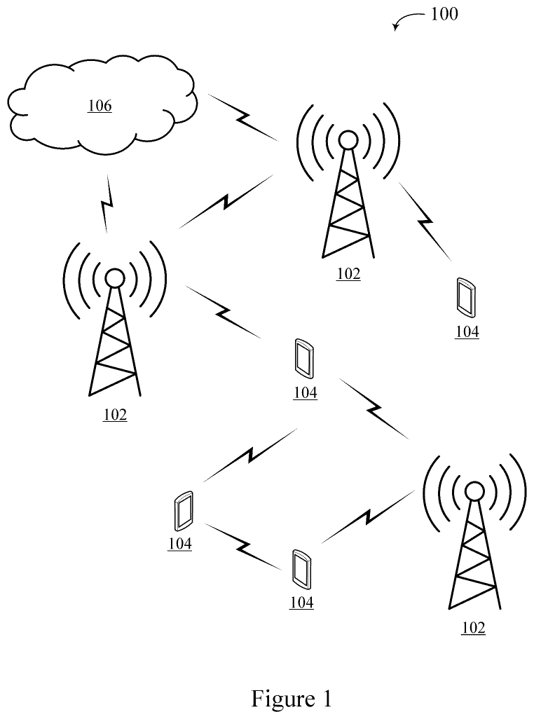

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a CP. A first numerology (e.g., μ=0) may be associated with a first subcarrier spacing (e.g., 15 kHz) and a normal CP. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal CP. A third numerology (e.g., μ=2) may be associated with a third subcarrier spacing (e.g., 60 kHz) and a normal CP or an extended CP. A fourth numerology (e.g., μ=3) may be associated with a fourth subcarrier spacing (e.g., 120 kHz) and a normal CP. A fifth numerology (e.g., μ=4) may be associated with a fifth subcarrier spacing (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal CP, a slot may include 14 symbols. For an extended CP (e.g., applicable for 60 kHz subcarrier spacing), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 uses one or more frame structures for different numerologies corresponding to different subcarrier spacings. The one or more frame structures have a fixed number of symbols in a slot and can use different CP durations without defining a numerology or a frame structure for different CP durations. A known sequence (e.g., a unique word) is used in the CP duration instead of random data for OFDM symbols in the slot. A known sequence refers to, for example, a sequence selected from a set of one or more sequences configured for the UE 104. The known sequence can be, for example, selected by the NE 102 and an indication of the selected known sequence communicated (e.g., transmitted, sent, signaled) to the UE 104, or can be selected by the UE 104 and an indication of the selected known sequence communicated (e.g., transmitted, sent, signaled) to the NE 102.

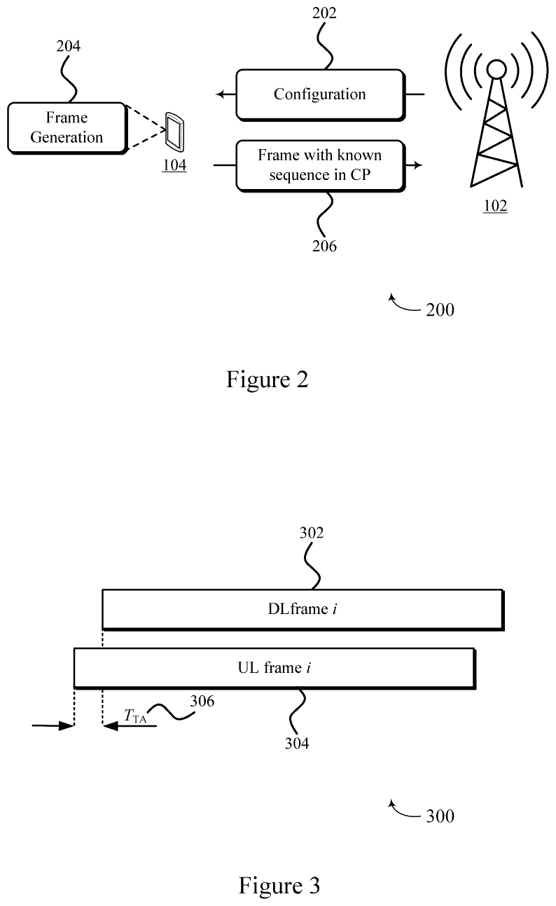

FIG. 2 illustrates an example 200 of wireless communication in accordance with aspects of the present disclosure. In the example 200, an NE 102 communicates (e.g., transmits, sends, signals) a configuration 202 (e.g., a configuration message) to a UE 104. The configuration 202 includes an indication of one or more CP durations for symbols scheduled in a slot of a frame. The UE 104 performs frame generation 204 to generate a frame 206 based on the configuration 202, and the UE 104 communicates (e.g., transmits, sends, signals) the frame 206 to the NE 102. The frame 206 has a fixed duration (e.g., a number of milliseconds (ms), such as 10 ms) and a number of symbols in the frame 206 are independent of the one or more CP durations for symbols scheduled in a slot of the frame 206. Put another way, the number of symbols in the frame 206 does not depend on the one or more CP durations for symbols scheduled in the slot of the frame 206. Accordingly, the frame 206 has a fixed duration but different symbols in a slot of the frame 206 can have different CP durations.

Returning to FIG. 1, in one or more implementations, the size of various fields in the time domain is expressed in time units T_{c}=1/(Δfₘₐₓ·N_{f}) where Δfₘₐₓ=480·10³ Hz and N_{f}=4096. The constant κ=Tₛ/T_{c}=64 where Tₛ=1/(Δf_{ref}·N_{f,ref}), Δf_{ref}=15·10³ Hz and N_{f,ref}=2048. In one or more implementations, the term “UE” is equally applicable to the integrated access and backhaul mobile termination (IAB-MT) part of an integrated access and backhaul (IAB) node and the network-controlled repeater mobile termination (NCR-MT) part of a network-controlled repeater (NCR) node.

Multiple OFDM numerologies are supported as given by Table 1 where μ and the CP for [symbol] or UL bandwidth part are obtained from the higher-layer parameters subcarrierSpacing and cyclicPrefix, respectively.

TABLE 1
Supported transmission numerologies.

| μ | Δf = 2^{μ} · 15[kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

In one or more implementations, DL, UL, and sidelink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. The number of consecutive OFDM symbols per subframe is

$${N}_{symb}^{subframe , μ} = {N}_{symb}^{slot} {N}_{slot}^{subframe , μ} .$$

Each frame is divided into two equally-sized half-frames of five subframes each with half-frame 0 consisting of subframes 0-4 and half-frame 1 consisting of subframes 5-9.

There is one set of frames in the UL and one set of frames in the DL on a carrier. UL frame number i for transmission from the UE shall start

$${T}_{TA} = ( {N}_{TA} + {N}_{TA , offset} + {N}_{T A , adj}^{common} + {N}_{T A , adj}^{U E} ) {T}_{c}$$

before the start of the corresponding DL frame at the UE where N_{TA} and N_{TA,offset} are given by clause 4.2 of 3^{rd} generation partnership project (3GPP) technical specification (TS) 38.213, except for msgA transmission on physical uplink shared channel (PUSCH) where N_{TA}=0 is used;

$${N}_{T A , adj}^{common}$$

given by clause 4.2 of 3GPP TS 38.213 is derived from the higher-layer parameters ta-Common, ta-CommonDrift, and ta-CommonDriftVariant if configured, otherwise

$${N}_{TA , adj}^{common} = 0 ; and {N}_{TA , adj}^{UE}$$

given by clause 4.2 of 3GPP TS 38.213 is computed by the UE based on UE position and serving-satellite-ephemeris-related higher-layers parameters if configured, or is computed by the UE based on UE position and gNB location provided by atg-gNB-Location if configured, otherwise

$${N}_{TA , adj}^{UE} = 0.$$

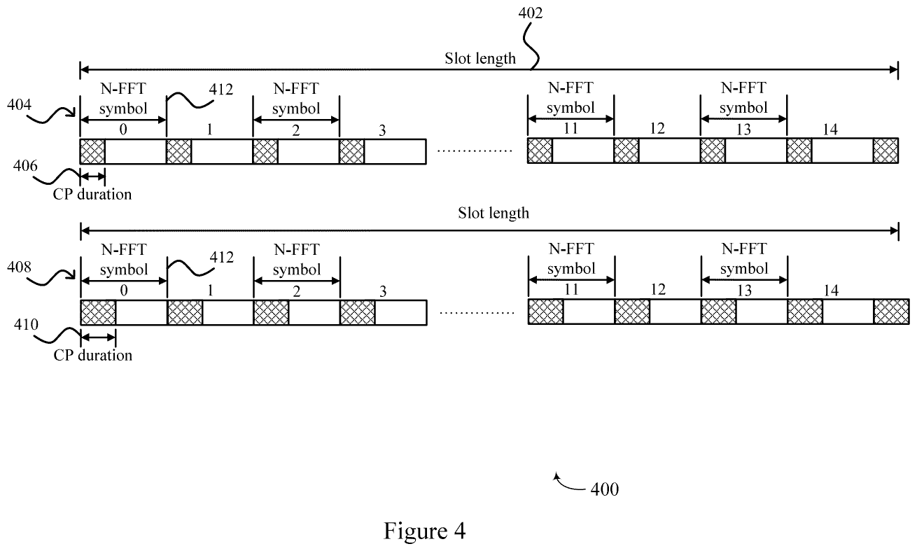

FIG. 3 illustrates an example 300 of a UL-DL timing relation in accordance with aspects of the present disclosure. The example 300 illustrates a DL frame 302 (DL frame i) and a UL frame 304 (UL frame i). As illustrated, the UL frame 304 starts an amount of time 306 (TTA) before the start of the DL frame 302.

Returning to FIG. 1, for subcarrier spacing configuration μ, slots are numbered

$${n}_{s}^{μ} ∈ \{ 0 , … , {N}_{slot}^{subframe , μ} - 1 \}$$

in increasing order within a subframe and

$${n}_{s , f}^{μ} ∈ \{ 0 , … , {N}_{slot}^{frame , μ} - 1 \}$$

in increasing order within a frame. There are

$${N}_{symb}^{slot}$$

consecutive OFDM symbols in a slot where

$${N}_{symb}^{slot}$$

depends on the CP as given by Tables 1 and Table 2 below. The start of slot

$${n}_{s}^{μ}$$

in a subframe is aligned in time with the start of OFDM symbol

$${n}_{s}^{μ} {N}_{symb}^{slot}$$

in the same subframe.

OFDM symbols in a slot in a DL or UL frame can be classified as ‘downlink’, ‘flexible’, or ‘uplink’. Signaling of slot formats is described in clause 11.1 of 3GPP TS 38.213. In a slot in a DL frame, the UE assumes that DL transmissions only occur in ‘downlink’ or ‘flexible’ symbols. In a slot in an UL frame, the UE only transmits in ‘uplink’ or ‘flexible’ symbols.

A UE not capable of full-duplex communication and not supporting simultaneous transmission and reception as defined by parameter simultaneousRxTxInterBandENDC, simultaneousRxTxInterBandCA or simultaneousRxTxSUL of 3GPP TS 38.306 among all cells within a group of cells is not expected to transmit in the UL in one cell within the group of cells earlier than N_{Rx-Tx}T_{c} after the end of the last received DL symbol in the same or different cell within the group of cells where N_{Rx-Tx} is given by Table 4 below.

A UE not capable of full-duplex communication and not supporting simultaneous transmission and reception as defined by parameter simultaneousRxTxInterBandENDC, simultaneousRxTxInterBandCA or simultaneousRxTxSUL of 3GPP TS 38.306 among all cells within a group of cells is not expected to receive in the DL in one cell within the group of cells earlier than N_{Tx-Rx}T_{c} after the end of the last transmitted UL symbol in the same or different cell within the group of cells where N_{Tx-Rx} is given by Table 4 below.

For dual active protocol stack (DAPS) handover operation, a UE not capable of full-duplex communication is not expected to transmit in the UL to a cell earlier than N_{Rx-Tx}T_{c} after the end of the last received DL symbol in the different cell where N_{Rx-Tx} is given by Table 4 below. For DAPS handover operation, a UE not capable of full-duplex communication is not expected to receive in the DL from a cell earlier than N_{Tx-Rx}T_{c} after the end of the last transmitted UL symbol in the different cell where N_{Tx-Rx} is given by 4 below.

A UE not capable of full-duplex communication is not expected to transmit in the UL earlier than N_{Rx-Tx}T_{c} after the end of the last received DL symbol in the same cell where N_{Rx-Tx} is given by Table 4 below. A UE not capable of full-duplex communication is not expected to receive in the DL earlier than N_{Tx-Rx}T_{c} after the end of the last transmitted UL symbol in the same cell where N_{Tx-Rx} is given by Table 4 below.

Table 2 identifies the number of OFDM symbols per slot, slots per frame, and slots per subframe for normal CP.

TABLE 2

| μ | ${N}_{symb}^{slot}$ | ${N}_{slot}^{frame , µ}$ | ${N}_{slot}^{subframe , µ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

Table 3 identifies the number of OFDM symbols per slot, slots per frame, and slots per subframe for extended CP.

TABLE 3

| μ | ${N}_{symb}^{slot}$ | ${N}_{slot}^{frame , µ}$ | ${N}_{slot}^{subframe , µ}$ |
|---|---|---|---|
| 2 | 12 | 40 | 4 |

Table 4 identifies the transition time N_{Rx-Tx} and N_{Tx-Rx}.

TABLE 4

| Transition time | FR1 | FR2 |
|---|---|---|
| N_{Tx-Rx} | 25600 | 13792 |
| N_{Rx-Tx} | 25600 | 13792 |

In CP-OFDM, CP is used as guard intervals between consecutive OFDM symbols to eliminate ISI among these symbols. Moreover, the use of CP as cyclic extension transforms the linear convolution of the transmit signal with the propagation channel into a cyclic convolution, thus enabling a block-wise low complexity equalization in the frequency domain. The duration of the CP is expected to be more than the coherence time of the propagation channel to avoid ISI, therefore, the CP duration depends on the coherence time of the channel. However, in practical scenarios, the use of variable CP durations that depend on propagation channel adds a lot of complexity since the frame structure with specific durations are defined. If variable CPs are to be used, then a lot of numerologies are to be defined for different set of CP durations, or the frame structure needs to be adoptive to change the CP durations without changing the number of symbols in a fixed slot or frame duration.

Such a frame structure, where the numerology does not depend on CP durations but supports different CP durations, can be realized using unique word OFDM (also referred to as key sequence OFDM), where the CP duration is part of the OFDM symbol generation (e.g., is part of IFFT duration). In this disclosure, frame structures are discussed that utilize different numerologies corresponding to different subcarrier spacings with a fixed number of symbols in a slot and may utilize different CP durations without the need to define a numerology or a frame structure for different CP durations. Also discussed is use of a known sequence (e.g., a unique word) in the CP duration instead of random data for one or more OFDM symbols inside the slot. Also discussed is a frame structure that is backward compatible but utilizes a unique word instead of a random CP. Signaling aspects for such frame structures is also discussed.

In one or more implementations, a flexible frame structure with CP duration independent numerology is used. A flexible frame structure is configured or defined that may employ different CP durations for different propagating channel conditions, but the supported numerologies are independent of the CP durations and the number of consecutive OFDM symbols in a slot of a DL or UL frame are always fixed for different subcarrier spacings. This implies that the number of symbols for a subcarrier spacing are fixed for a slot duration, whereas the CP duration of one or multiple OFDM symbols within the slot may change without the change of number of OFDM symbols and/or the length of slot. This is accomplished by using a CP as part of OFDM duration (inside IFFT duration) and that is not added separately to OFDM symbol.

In one or more implementations, DL and UL transmissions may be organized into frames similar to NR frames with T_{f}=(Δfₘₐₓ·N_{f}/100)·T_{c}=10 ms) duration, each consisting of ten subframes of T_{sf}=(Δfₘₐₓ·N_{f}/1000)·T_{c}=1 ms) duration. The number of consecutive OFDM symbols per subframe is

$${N}_{slot}^{subframe , μ} = {N}_{symb}^{slot} {N}_{slot}^{subframe , μ} .$$

For subcarrier spacing configuration μ, slots are numbered

$${n}_{s}^{μ} ∈ \{ 0 , … , {N}_{slot}^{subframe , μ} - 1 \}$$

in increasing order within a subframe and

$${n}_{s , f}^{μ} ∈ \{ 0 , … , {N}_{slot}^{frame , μ} - 1 \}$$

in increasing order withing a frame. In some examples, thee are

$${N}_{symb}^{slot} = 15$$

consecutive OFDM symbols in a slot where

$${N}_{symb}^{slot}$$

does not depend on the CP and is fixed for all subcarrier spacings. The start of slot

$${n}_{s}^{μ}$$

in a subframe is aligned in time with the start of OFDM symbol

$${n}_{s}^{μ} {N}_{symb}^{slot}$$

in the same subframe. Therefore, the number of OFDM symbols per slot, slots per frame, and slots per subframe are independent of the CP duration and are configured or defined for different subcarrier spacings. Table 5 identifies the number of OFDM symbols per slot, slots per frame, and slots per subframe independent of CP durations in one example.

TABLE 5

| μ | Δf = 2^{μ} · 15 [kHz] | ${N}_{symb}^{slot}$ | ${N}_{slot}^{frame , µ}$ | ${N}_{slot}^{subframe , µ}$ |
|---|---|---|---|---|
| 0 | 15 | 15 | 10 | 1 |
| 1 | 30 | 15 | 20 | 2 |
| 2 | 60 | 15 | 40 | 4 |
| 3 | 120 | 15 | 80 | 8 |
| 4 | 240 | 15 | 160 | 16 |
| 5 | 480 | 15 | 320 | 32 |
| 6 | 960 | 15 | 640 | 64 |

Such a configuration implies that slot length (e.g., in terms of time duration or number of symbols) is fixed and changing the CP duration of the symbols in the slot would not change the number of symbols in the slot or slot duration or OFDM symbol duration.

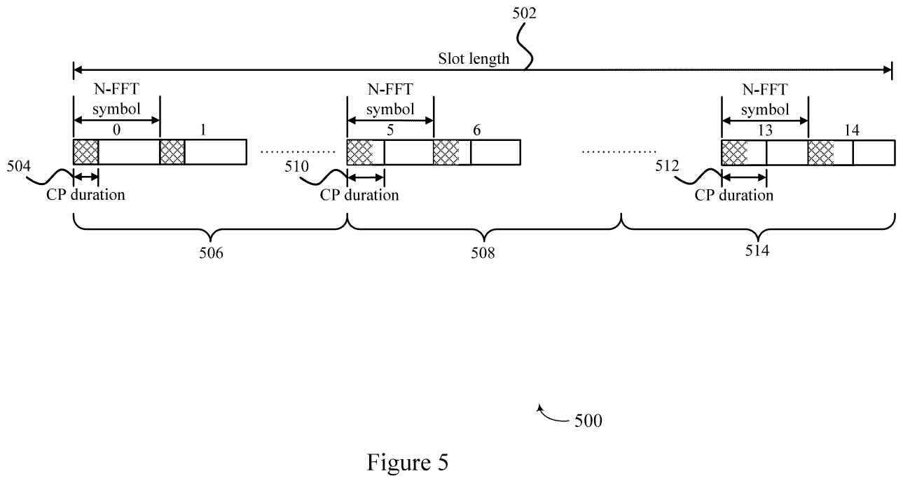

FIG. 4 illustrates an example of a flexible frame structure 400 in accordance with aspects of the present disclosure. The flexible frame structure 400 has CP duration independent numerology and uses unique words or key sequences as CPs. For example, a slot having a slot length 402 of 1 ms corresponding to 15 kHz subcarrier spacing and 15 symbols with different CP durations. The CPs are illustrated with crosshatching. Depending on the propagation channel between the UE and the NE, the appropriate (e.g., best) CP duration may be chosen without the need to change the slot duration or frame structure. The slot may be configured as illustrated at 404 with a shorter CP duration 406, or configured as illustrated at 408 with a longer CP duration 410. Regardless of the length of the unique word or key sequence, the OFDM symbol duration 412 is the same.

In one or more implementations, the total duration of the configured resources in frames or subframes is increased by the CP duration as a unique word of CP duration is appended at the end or start of the frame to have cyclic convolution.

In one or more implementations, the same CP (e.g., unique word or key sequence) duration is used for all the symbols in the slot or subframe or frame. Additionally or alternatively, different symbols in the slot may have different CP (e.g., unique word or key sequence) durations. For example, if there are 15 symbols in the slot, then the slot may be divided into three sub-slots with each sub-slot having different CP (e.g., unique word or key sequence) durations or lengths.

In one or more implementations, when different CP durations are used inside the same slot, the same unique word or key sequence with different length (in other words, the different unique words or key sequences associated with different unique word length, but with a shared starting segment, such that a unique word or key sequence with a smaller length is the same as the starting segment of a unique word or key sequence with a larger length) is used to have cyclic convolution property and so that the slot duration is not changed.

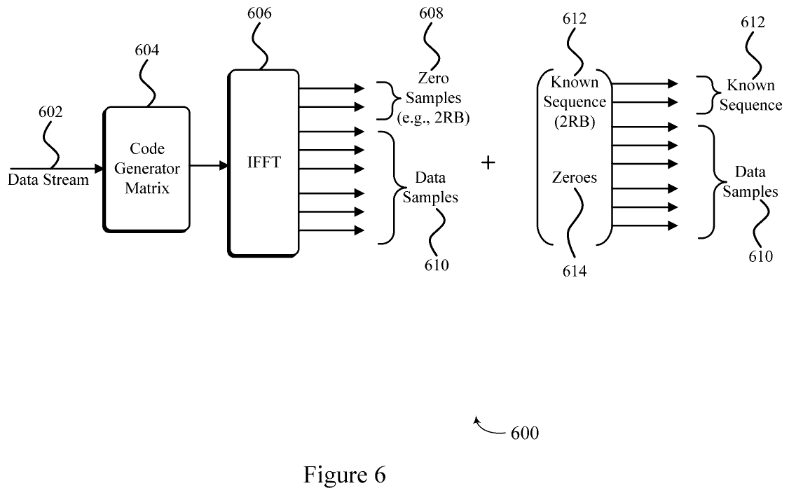

FIG. 5 illustrates an example 500 of variable CP durations in accordance with aspects of the present disclosure. The example 500 illustrates a slot with symbols of variable CP durations without change of slot duration. The slot has a slot length 502 and 15 symbols with different CP durations. The example 500 uses unique words or key sequences as CPs. Assume a unique word or key sequence with length 12 (CP duration 504), illustrated with cross-hatching, is used for the first five symbols 506 and for the second five symbols 508 the length is to be increased to 18 (CP duration 510). Then, the same sequence of length 12 would be extended to length 18, where the first 12 symbols from the 18-length sequence would be same as used in the first five symbols 506. Similarly, if a unique word or key sequence with length 22 (CP duration 512) is used for the last five symbols 514, the same sequence of length 18 would be extended to length 22, where the first 12 symbols from the 22-length sequence would be the same as used in the first five symbols 506, and the first 18 symbols from the 22-length sequence would be the same as used in the second five symbols 508.

Returning to FIG. 1, in one or more implementations the CP duration configuration is within a CP independent numerology. CP durations are configured separately and are part of the symbol duration, where a set of matrices, referred to as code generator matrices, that may generate different CP durations after the application of IFFT are specified. The UE is indicated with an index corresponding to one matrix from the set of matrices in order for the UE to align the use of the same code generator matrix at transmitter and receiver to avoid mismatch errors, thus avoiding the loss of spectral efficiency.

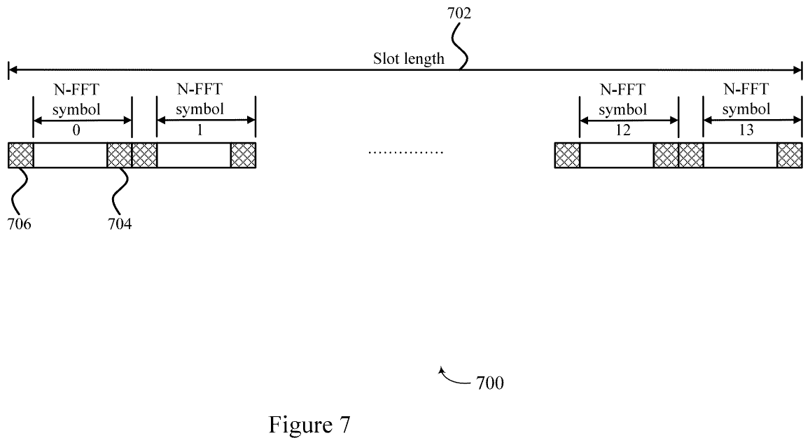

FIG. 6 illustrates an example 600 of generation of variable CP durations in accordance with aspects of the present disclosure. The example 600 illustrates generation of variable CP durations within an OFDM symbol. In one or more implementations, a data stream 602 (data to be transmitted) is input to or obtained by a code generator matrix 604 that is applied just before the IFFT operation 606. The code generator matrix 604 results in zeroes 608 being generated at the output of the IFFT operation 606. Accordingly, the IFFT interval includes the zeroes 608 and data samples 610 from the data stream 602. A known sequence 612 (e.g., a unique word) of the intended CP duration length is added to the time domain data without increasing the length of the symbol whereas zeroes 614 are added to the data samples 610. Accordingly, the symbol includes the known sequence 612 and the data samples 610. The position of the zeroes 608 at the output of the IFFT may be at the start or end of the IFFT output, depending on the frame structure design. Different code generator matrices are used for generating zeroes at the start or at the end of time domain OFDM symbol.

In one or more implementations, instead of generating zeroes at the output of the IFFT operation 606, the code generator matrix 604 directly generates the desired symbol (known sequence (e.g., a unique word)) in the CP duration where the desired symbol can be at the start or at the end of the OFDM symbol.

In one or more implementations, a default length of the code generator matrix 604 is used if no index or length of CP duration is part of the configuration received by the UE. This implies that a code generator matrix 604 that generates a length of CP duration (e.g., corresponding to a perceived or determined to be optimal CP duration) would be implicitly indicated as a default matrix for a default CP duration for all the symbols in the frame until otherwise configured.

In one or more implementations, a mapping between the code generator matrix and length of the time domain known sequence (e.g., a unique word) corresponding to the CP duration is configured or specified and an index is configured to the UE (e.g., from an NE). Based on the configured index, the UE selects the corresponding code generator matrix and CP or unique known sequence (e.g., a unique word) length. An example illustration of such mapping table is shown in Table 6.

TABLE 6
An example table illustrating a mapping relation of
CP duration and code generator matrix for an FFT size

| | Code Generator | CP duration/unique |
|---|---|---|
| Index | Matrix | word length |
| 0 | G1 | 1 resource block |
| | | (RB) |
| 1 | G2 | 1.5 RB |
| 2 | G3 | 2 RB |
| 3 | G4 | 2.5 RB |
| 4 | G5 | 3 RB |

In one or more implementations, only CP duration or known sequence (e.g., a unique word) length is indicated, and the UE based on the indicated CP duration or unique word length chooses the corresponding code generator matrix.

In one or more implementations, the code generator matrix 604 is not indicated to the UE. Nevertheless, the UE determines the necessary processing of the input data stream based on a pre-configured, configured, or indicated one or more of the length or duration of the known sequence (e.g., a unique word), a unique word sequence (e.g., as an index indicating a known sequence for the unique word segment), symbol duration, subcarrier spacing, or number of fast Fourier transform points (NFFT) length.

In one or more implementations, a legacy frame structure with a known sequence (e.g., a unique word) in the CP is used. A frame structure like the legacy CP-OFDM is used, where instead of using random CP (copying the last part of IFFT output at the start), a known sequence (e.g., a unique word) is added at the end of time domain samples within the FFT interval, and the same symbol is copied outside the FFT interval.

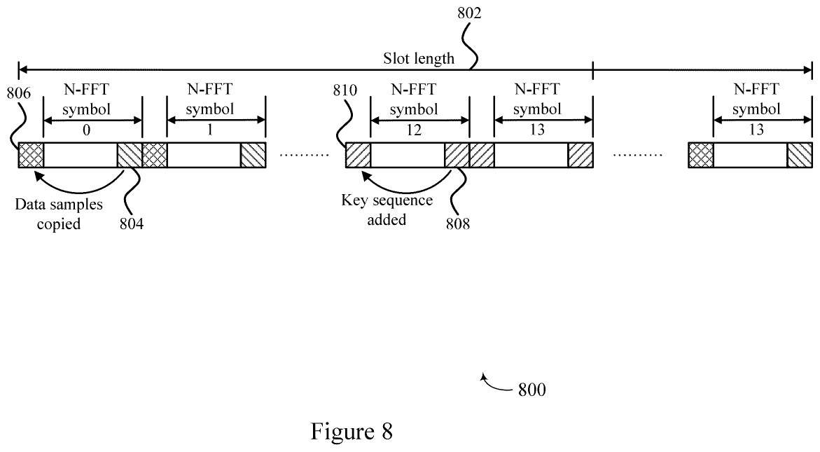

FIG. 7 illustrates an example 700 of a legacy frame structure with a known sequence in accordance with aspects of the present disclosure. The example 700 illustrates a legacy frame structure with a known sequence (e.g., a unique word) as CP. The example 700 illustrates a slot having a slot length 702. The CPs are illustrated with crosshatching. For example, a known sequence (e.g., a unique word) is added as a CP 704 at the end of the symbol within the FFT interval, and the same known sequence (e.g., a unique word) is copied and added as a CP 706 outside of the FFT interval.

In some examples, this can be accomplished by using the code generator matrix discussed above to generate zeroes at the output of IFFT within the IFFT interval. Then the known sequence (e.g., a unique word) is added at the zero-sample positions and the known sequence (e.g., a unique word) is also copied at the start of the symbol, thus increasing the OFDM symbol duration by the CP duration. Such a slot or frame structure provides multiple benefits. For example, the CP which is redundant and is not utilized for any other purpose, can now be utilized for any desired task, e.g., sensing, channel estimation and synchronization. By way of another example, this slot or frame structure it provides backward compatibility since the frame structure would not change if a legacy (e.g., 5G NR) CP-OFDM waveform is used.

In one or more implementations, when such frame structure is used, a UE may be configured with a code generator matrix index and a CP duration, where one CP duration may use different code generator matrices. If such a configuration is received by the UE, the UE would use the same code generator matrix for all of the symbols in the slot.

In one or more implementations, if a UE receives a configuration with a code generator matrix and a CP duration, and if the code generator matrix is an identity matrix, this implicitly implies that random data at the output of the IFFT of the CP duration would be used for the CP, as in legacy (e.g., 5G NR) OFDM symbols. Additionally or alternatively, if the code generator matrix is not an identity matrix, then the UE would add a known sequence (e.g., a unique word) at zero samples and would also use the known sequence (e.g., a unique word) at the start of the symbol. In one or more implementations, different code generator matrices may be configured for the same CP duration, thus implying the use of combination of unique word and CP based symbol in the same slot.

FIG. 8 illustrates an example 800 of a legacy frame structure with a known sequence in accordance with aspects of the present disclosure. The example 800 illustrates a legacy frame structure with a combination of known sequence (e.g., a unique word) and CP based OFDM symbols. The example 800 illustrates a slot having a slot length 802. For some symbols, random data 804 (illustrated with lower left to upper right fill) is copied and used as the CP 806 (illustrated with crosshatching). For other symbols, a known sequence 808 (e.g., a unique word), illustrated with upper left to lower right fill is added at zero samples in the output of the IFFT and at the start 810 of the symbol.

In one or more implementations, the location of the application of different code generator matrices is predefined. For instance, if a code generator matrix other than the identity matrix is used, then the UE would implicitly use the other code generator matrix at the pre-defined symbol location in the slot. The UE would add a known sequence (e.g., a unique word) of CP length at those symbol locations instead of using legacy CP based OFDM symbol generation.

In one or more implementations, the code generator matrix for each symbol location in the slot is also defined as part of the configuration.

Returning to FIG. 1, with respect to a reporting configuration, in one or more implementations, based on the reporting from the UE where the report includes an implicit or indication about the choice of CP duration for subsequent transmission, the NE chooses an appropriate CP duration (thus a unique word length) and indicates the CP duration (or known sequence (e.g., a unique word) length) to the UE along with a code generator matrix. Additionally or alternatively, the NE determines an appropriate (e.g., deemed to be the best) CP duration based on an estimate of the channel coherence time of the UL reception channel from the UE and indicates the determined CP duration to the UE.

In one or more implementations, the NE selects a CP duration based on a CSI report from the UE. For example, the UE is configured with CSI resources with a code generator matrix that generates a frame structure with a default CP duration. The UE performs CSI measurements and sends a CSI report with default CSI parameters such as channel quality indicator (CQI), precoding matrix indicator (PMI), or rank indicator (RI). Based on the CQI value, the NE estimates the channel conditions experienced by the UE. Based on the channel conditions, the NE configures the appropriate code generator matrix that generates a desired CP duration in the slot or frame.

In one or more implementations, a mapping between group of CQI values and CP duration may be used as the CP duration (and thus the length of the known sequence (e.g., a unique word)) which may have a direct relationship with a CQI value. For example, higher CQI values would correspond to lower CP duration and lower CQI values would indicate a higher CP duration.

Based on channel estimation performed by the UE using frequency domain pilot symbols, the UE can determine a channel impulse response length and thus the appropriate CP duration. Accordingly, in one or more implementations, the UE indicates the CP duration to the NE based on the estimated channel impulse response. This can be part of a CSI report with a field indicating CP duration. Additionally or alternatively, the UE may send a dedicated report indicating appropriate CP duration or unique word length and/or an index corresponding to a code generator matrix, e.g., in UL control information, in UL shared channel, or as part of UL control channel.

In one or more implementations, a UE is configured with a slot or frame consisting of OFDM symbols with variable CP durations, e.g., a slot as shown above in FIG. 5. The UE may also receive an indication to perform channel estimation on each set of known sequence (e.g., a unique word) lengths or when such a slot is configured, which implies an implicit indication to the UE that the UE needs to perform channel estimation on different known sequence (e.g., a unique word) lengths. Once such configuration is received by the UE, and the UE would indicate to the NE which of the CP duration (known sequence (e.g., a unique word) length) is to be used (e.g., is determined to be best or optimal) for the current channel conditions. This reporting mechanism can be part of other measurements such as CSI measurement reports, where some fields may be used to indicate the known sequence (e.g., a unique word) length to be used, or a separate dedicated reporting measurement and reporting procedure is used to indicate to the network about the CP duration (or known sequence (e.g., a unique word) length) to be used.

The procedure can operate as follows. The NE configures a slot or multiple slots with variable CP durations, thus different known sequence (e.g., a unique word) lengths. The NE may also indicate in the configuration whether to report a CP duration to be used (e.g., an optimal CP duration). The NE may also indicate the different code generating matrices corresponding to different CP durations or known sequence (e.g., a unique word) lengths in the same configuration. The UE, upon reception of such a configuration, performs measurements on multiple known sequences (e.g., a unique words) corresponding to different lengths. The UE would communicates (e.g., transmits, sends) a report to the NE about the a CP duration or known sequence (e.g., a unique word) length or code generator matrix (e.g., a best or optimal CP duration or unique word length or code generator matrix).

Accordingly, the signaling and procedures discussed herein includes a flexible frame structure design with numerology that is independent of any CP duration that needs to be employed. The signaling and procedures discussed herein further includes variable CP duration configurations with one CP duration for one slot or sub-frame or frame, or multiple CP durations within a slot or sub-frame or frame. The signaling and procedures discussed herein further include a legacy frame structure with a known sequence (e.g., a unique word) and CP based symbols. The signaling and procedures discussed herein further include selection of an appropriate CP duration based on UE reporting.

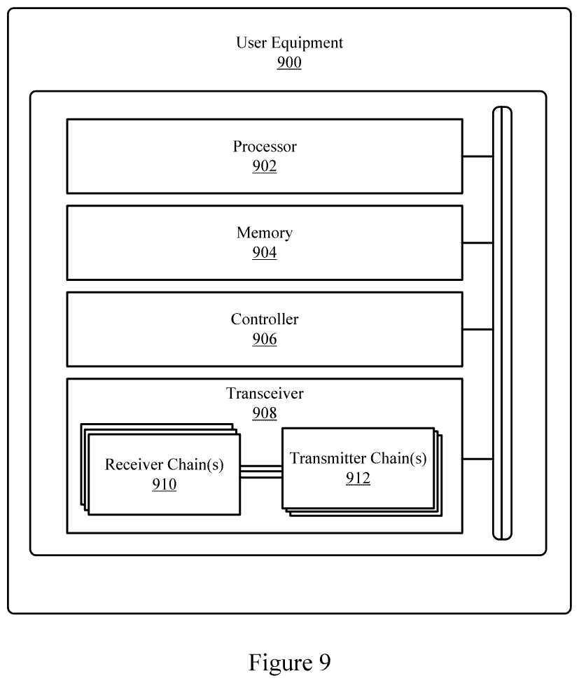

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving an indication of one or more CP durations for one or more symbols in a slot of a frame, where the frame has a fixed duration, and where a number of symbols in the frame are independent of the one or more CP durations; and transmitting the frame, where the frame includes, in a CP duration for each symbol a CP including at least one known sequence appended in a time domain.

Additionally, the UE 900 may be configured to support any one or combination of where each symbol in the frame comprises an OFDM symbol, and where for each OFDM symbol, the CP duration comprises part of an IFFT duration of the OFDM symbol; using a same CP duration for all of the symbols in the slot of the frame; where each symbol in the frame comprises an OFDM symbol, and where the indication comprises a configuration that includes, for each OFDM symbol, an index for a code generator matrix that generates zeroes corresponding to the CP duration at an IFFT output within a duration of the OFDM symbol; where a look-up table defines a one-to-one relationship of each of multiple code generator matrices to a CP duration or a known sequence length for a FFT length; where the configuration further includes an index that identifies a code generator matrix of the multiple code generator matrices and the known sequence length from the look-up table; receiving a configuration that indicates to use different CP durations within a slot or across slots, where the configuration includes a set of indices for code generator matrices for each of the different CP durations; applying a same code generator matrix for each symbol having a same CP duration; generating the at least one known sequence that has a length corresponding to a largest CP duration; and using the generated at least one known sequence inside each of the different CP durations; where each symbol in the frame comprises an OFDM symbol; receiving an indication to use the at least one known sequence in the one or more CP durations for at least one of the OFDM symbols in a slot of a frame, where the at least one known sequence includes a first known sequence at an end of the OFDM symbol and a second known sequence at a start of the OFDM symbol, where the first known sequence and the second known sequence have a same length, where the first known sequence is part of an IFFT interval, and where the second known sequence is added as an additional CP duration, and where the frame includes at least one symbol with the second known sequence added at the start of the OFDM symbol as a CP and the first known sequence added at the end of a duration of the OFDM symbol; where the first known sequence and the second known sequence are a same sequence with a same length; receiving an indication of a position of symbols in the slot with second known sequence added at the start as the CP and the first known sequence added at the end of the duration of the OFDM symbol; using an identity matrix as a code generator matrix for symbols in the slot with random data as CP; receiving a reporting configuration that includes an indication of a selection of a CP duration out of a set of configured CP durations based at least in part on propagating channel conditions; and transmitting a report that includes at least an indication of a length of the CP duration; where the report comprises a CSI report; where the report includes a field that indicates a length of the at least one known sequence; where the report includes an indication of an index derived from mapping of CQI and the one or more CP durations to select a length of the at least one known sequence.

Additionally, or alternatively, the UE 900 may support at least one memory (e.g., the memory 904) and at least one processor (e.g., the processor 902) coupled with the at least one memory and configured to or operable to cause the UE to: receive an indication of one or more CP durations for one or more symbols in a slot of a frame, where the frame has a fixed duration, and where a number of symbols in the frame are independent of the one or more CP durations; and transmit the frame, where the frame includes, in a CP duration for each symbol a CP including at least one known sequence appended in a time domain.

Additionally, the UE 900 may be configured to or operable to support any one or combination of where each symbol in the frame comprises an OFDM symbol, and where for each OFDM symbol, the CP duration comprises part of an IFFT duration of the OFDM symbol; where the at least one processor is further operable to cause the UE to use a same CP duration for all of the symbols in the slot of the frame; where each symbol in the frame comprises an OFDM symbol, and where the indication comprises a configuration that includes, for each OFDM symbol, an index for a code generator matrix that generates zeroes corresponding to the CP duration at an IFFT output within a duration of the OFDM symbol; where a look-up table defines a one-to-one relationship of each of multiple code generator matrices to a CP duration or a known sequence length for a FFT length; where the configuration further includes an index that identifies a code generator matrix of the multiple code generator matrices and the known sequence length from the look-up table; where the at least one processor is further operable to cause the UE to: receive a configuration that indicates to use different CP durations within a slot or across slots, where the configuration includes a set of indices for code generator matrices for each of the different CP durations; apply a same code generator matrix for each symbol having a same CP duration; generate the at least one known sequence that has a length corresponding to a largest CP duration; and use the generated at least one known sequence inside each of the different CP durations; where each symbol in the frame comprises an OFDM symbol, and where the at least one processor is further operable to cause the UE to: receive an indication to use the at least one known sequence in the one or more CP durations for at least one of the OFDM symbols in a slot of a frame, where the at least one known sequence includes a first known sequence at an end of the OFDM symbol and a second known sequence at a start of the OFDM symbol, where the first known sequence and the second known sequence have a same length, where the first known sequence is part of an IFFT interval, and where the second known sequence is added as an additional CP duration, and where the frame includes at least one symbol with the second known sequence added at the start of the OFDM symbol as a CP and the first known sequence added at the end of a duration of the OFDM symbol; where the first known sequence and the second known sequence are a same sequence with a same length; where the at least one processor is further operable to cause the UE to receive an indication of a position of symbols in the slot with second known sequence added at the start as the CP and the first known sequence added at the end of the duration of the OFDM symbol; the at least one processor is further operable to cause the UE to use an identity matrix as a code generator matrix for symbols in the slot with random data as CP; where the at least one processor is further operable to cause the UE to receive a reporting configuration that includes an indication of a selection of a CP duration out of a set of configured CP durations based at least in part on propagating channel conditions; and transmit a report that includes at least an indication of a length of the CP duration; where the report comprises a CSI report; where the report includes a field that indicates a length of the at least one known sequence; where the report includes an indication of an index derived from mapping of CQI and the one or more CP durations to select a length of the at least one known sequence.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

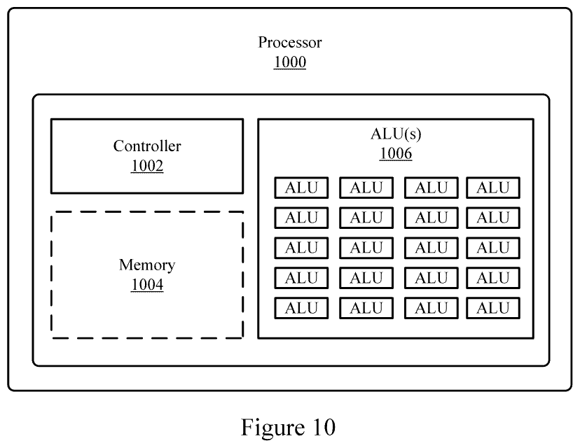

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to or operable to cause the processor to: receive an indication of one or more CP durations for one or more symbols in a slot of a frame, where the frame has a fixed duration, and where a number of symbols in the frame are independent of the one or more CP durations; and transmit the frame, where the frame includes, in a CP duration for each symbol a CP including at least one known sequence appended in a time domain.

Additionally, the processor 1000 may be configured to or operable to support any one or combination of where each symbol in the frame comprises an OFDM symbol, and where for each OFDM symbol, the CP duration comprises part of an IFFT duration of the OFDM symbol; where the at least one controller is further operable to cause the processor to use a same CP duration for all of the symbols in the slot of the frame; where each symbol in the frame comprises an OFDM symbol, and where the indication comprises a configuration that includes, for each OFDM symbol, an index for a code generator matrix that generates zeroes corresponding to the CP duration at an IFFT output within a duration of the OFDM symbol; where a look-up table defines a one-to-one relationship of each of multiple code generator matrices to a CP duration or a known sequence length for a FFT length; where the configuration further includes an index that identifies a code generator matrix of the multiple code generator matrices and the known sequence length from the look-up table; where the at least one controller is further operable to cause the processor to: receive a configuration that indicates to use different CP durations within a slot or across slots, where the configuration includes a set of indices for code generator matrices for each of the different CP durations; apply a same code generator matrix for each symbol having a same CP duration; generate the at least one known sequence that has a length corresponding to a largest CP duration; and use the generated at least one known sequence inside each of the different CP durations; where each symbol in the frame comprises an OFDM symbol, and where the at least one controller is further operable to cause the processor to receive an indication to use the at least one known sequence in the one or more CP durations for at least one of the OFDM symbols in a slot of a frame, where the at least one known sequence includes a first known sequence at an end of the OFDM symbol and a second known sequence at a start of the OFDM symbol, where the first known sequence and the second known sequence have a same length, where the first known sequence is part of an IFFT interval, and where the second known sequence is added as an additional CP duration, and where the frame includes at least one symbol with the second known sequence added at the start of the OFDM symbol as a CP and the first known sequence added at the end of a duration of the OFDM symbol; where the first known sequence and the second known sequence are a same sequence with a same length; where the at least one controller is further operable to cause the processor to receive an indication of a position of symbols in the slot with second known sequence added at the start as the CP and the first known sequence added at the end of the duration of the OFDM symbol; where the at least one controller is further operable to cause the processor to use an identity matrix as a code generator matrix for symbols in the slot with random data as CP where the at least one processor is further operable to cause the UE to: receive a reporting configuration that includes an indication of a selection of a CP duration out of a set of configured CP durations based at least in part on propagating channel conditions; and transmit a report that includes at least an indication of a length of the CP duration; where the report comprises a CSI report; where the report includes a field that indicates a length of the at least one known sequence; where the report includes an indication of an index derived from mapping of CQI and the one or more CP durations to select a length of the at least one known sequence.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to: transmit an indication of one or more CP durations for one or more symbols in a slot of a frame, where the frame has a fixed duration, and where a number of symbols in the frame are independent of the one or more CP durations; and receive the frame, where the frame includes, in a CP duration for each symbol a CP including at least one known sequence appended in a time domain.

Additionally, the processor 1000 may be configured to or operable to support any one or combination of where each symbol in the frame comprises an OFDM symbol, and where for each OFDM symbol, the CP duration comprises part of an IFFT duration of the OFDM symbol; where a same CP duration is used for all of the symbols in the slot of the frame; where each symbol in the frame comprises an OFDM symbol, and where the indication comprises a configuration that includes, for each OFDM symbol, an index for a code generator matrix that generates zeroes corresponding to the CP duration at an IFFT output within a duration of the OFDM symbol; where a look-up table defines a one-to-one relationship of each of multiple code generator matrices to a CP duration or a known sequence length for a FFT length; where the configuration further includes an index that identifies a code generator matrix of the multiple code generator matrices and the known sequence length from the look-up table; where the at least one controller is further operable to cause the processor to transmit a configuration that indicates to use different CP durations within a slot or across slots, where the configuration includes a set of indices for code generator matrices for each of the different CP durations; where each symbol in the frame comprises an OFDM symbol, and where the at least one controller is further operable to cause the processor to: transmit an indication to use the at least one known sequence in the one or more CP durations for at least one of the OFDM symbols in a slot of a frame, where the at least one known sequence includes a first known sequence at an end of the OFDM symbol and a second known sequence at a start of the OFDM symbol, where the first known sequence and the second known sequence have a same length, where the first known sequence is part of an IFFT interval, and where the second known sequence is added as an additional CP duration, and where the frame includes at least one symbol with the second known sequence added at the start of the OFDM symbol as a CP and the first known sequence added at the end of a duration of the OFDM symbol; where the first known sequence and the second known sequence are a same sequence with a same length; where the at least one controller is further operable to cause the processor to transmit an indication of a position of symbols in the slot with second known sequence added at the start as the CP and the first known sequence added at the end of the duration of the OFDM symbol; where the at least one controller is further operable to cause the processor to: transmit a reporting configuration that includes an indication of a selection of a CP duration out of a set of configured CP durations based at least in part on propagating channel conditions; and receive a report that includes at least an indication of a length of the CP duration; where the report comprises a CSI report; where the report includes a field that indicates a length of the at least one known sequence; where the report includes an indication of an index derived from mapping of CQI and the one or more CP durations to select a length of the at least one known sequence.

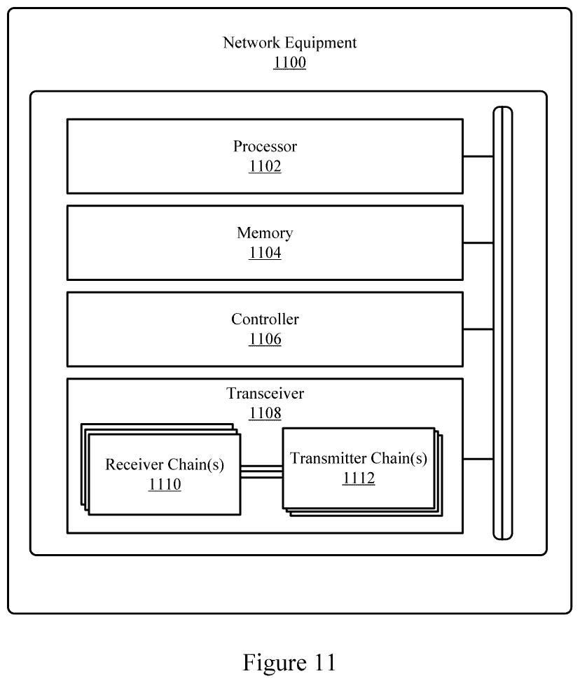

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to support a means for transmitting an indication of one or more CP durations for one or more symbols in a slot of a frame, where the frame has a fixed duration, and where a number of symbols in the frame are independent of the one or more CP durations; and receiving the frame, where the frame includes, in a CP duration for each symbol a CP including at least one known sequence appended in a time domain.

Additionally, the NE 1100 may be configured to support any one or combination of where each symbol in the frame comprises an OFDM symbol, and where for each OFDM symbol, the CP duration comprises part of an IFFT duration of the OFDM symbol; where a same CP duration is used for all of the symbols in the slot of the frame; where each symbol in the frame comprises an OFDM symbol, and where the indication comprises a configuration that includes, for each OFDM symbol, an index for a code generator matrix that generates zeroes corresponding to the CP duration at an IFFT output within a duration of the OFDM symbol; where a look-up table defines a one-to-one relationship of each of multiple code generator matrices to a CP duration or a known sequence length for a FFT length; where the configuration further includes an index that identifies a code generator matrix of the multiple code generator matrices and the known sequence length from the look-up table; transmitting a configuration that indicates to use different CP durations within a slot or across slots, where the configuration includes a set of indices for code generator matrices for each of the different CP durations; where each symbol in the frame comprises an OFDM symbol; transmitting an indication to use the at least one known sequence in the one or more CP durations for at least one of the OFDM symbols in a slot of a frame, where the at least one known sequence includes a first known sequence at an end of the OFDM symbol and a second known sequence at a start of the OFDM symbol, where the first known sequence and the second known sequence have a same length, where the first known sequence is part of an IFFT interval, and where the second known sequence is added as an additional CP duration, and where the frame includes at least one symbol with the second known sequence added at the start of the OFDM symbol as a CP and the first known sequence added at the end of a duration of the OFDM symbol; where the first known sequence and the second known sequence are a same sequence with a same length; transmitting an indication of a position of symbols in the slot with second known sequence added at the start as the CP and the first known sequence added at the end of the duration of the OFDM symbol; transmitting a reporting configuration that includes an indication of a selection of a CP duration out of a set of configured CP durations based at least in part on propagating channel conditions; and receiving a report that includes at least an indication of a length of the CP duration; where the report comprises a CSI report; where the report includes a field that indicates a length of the at least one known sequence; where the report includes an indication of an index derived from mapping of CQI and the one or more CP durations to select a length of the at least one known sequence.

Additionally, or alternatively, the NE 1100 may support at least one memory (e.g., the memory 1104) and at least one processor (e.g., the processor 1102) coupled with the at least one memory and configured to or operable to cause the NE to: transmit an indication of one or more CP durations for one or more symbols in a slot of a frame, where the frame has a fixed duration, and where a number of symbols in the frame are independent of the one or more CP durations; and receive the frame, where the frame includes, in a CP duration for each symbol a CP including at least one known sequence appended in a time domain.

Additionally, the NE 1100 may be configured to support any one or combination of where each symbol in the frame comprises an OFDM symbol, and where for each OFDM symbol, the CP duration comprises part of an IFFT duration of the OFDM symbol; where a same CP duration is used for all of the symbols in the slot of the frame; where each symbol in the frame comprises an OFDM symbol, and where the indication comprises a configuration that includes, for each OFDM symbol, an index for a code generator matrix that generates zeroes corresponding to the CP duration at an IFFT output within a duration of the OFDM symbol; where a look-up table defines a one-to-one relationship of each of multiple code generator matrices to a CP duration or a known sequence length for a FFT length; where the configuration further includes an index that identifies a code generator matrix of the multiple code generator matrices and the known sequence length from the look-up table; where the at least one processor is further operable to cause the NE to transmit a configuration that indicates to use different CP durations within a slot or across slots, where the configuration includes a set of indices for code generator matrices for each of the different CP durations; where each symbol in the frame comprises an OFDM symbol, and where the at least one processor is further operable to cause the NE to: transmit an indication to use the at least one known sequence in the one or more CP durations for at least one of the OFDM symbols in a slot of a frame, where the at least one known sequence includes a first known sequence at an end of the OFDM symbol and a second known sequence at a start of the OFDM symbol, where the first known sequence and the second known sequence have a same length, where the first known sequence is part of an IFFT interval, and where the second known sequence is added as an additional CP duration, and where the frame includes at least one symbol with the second known sequence added at the start of the OFDM symbol as a CP and the first known sequence added at the end of a duration of the OFDM symbol; where the first known sequence and the second known sequence are a same sequence with a same length; where the at least one processor is further operable to cause the NE to transmit an indication of a position of symbols in the slot with second known sequence added at the start as the CP and the first known sequence added at the end of the duration of the OFDM symbol; where the at least one processor is further operable to cause the NE to: transmit a reporting configuration that includes an indication of a selection of a CP duration out of a set of configured CP durations based at least in part on propagating channel conditions; and receive a report that includes at least an indication of a length of the CP duration; where the report comprises a CSI report; where the report includes a field that indicates a length of the at least one known sequence; where the report includes an indication of an index derived from mapping of CQI and the one or more CP durations to select a length of the at least one known sequence.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

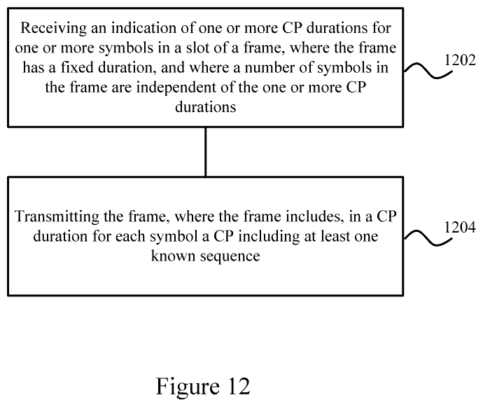

FIG. 12 illustrates a flowchart of a method in accordance with aspects of the present disclosure. The operations of the method may be implemented by a UE as described herein. In some implementations, the UE may execute a set of instructions to control the function elements of the UE to perform the described functions.

At 1202, the method may include receiving an indication of one or more CP durations for one or more symbols in a slot of a frame, where the frame has a fixed duration, and where a number of symbols in the frame are independent of the one or more CP durations. The operations of 1202 may be performed in accordance with examples as described herein. In some implementations, aspects of the operations of 1202 may be performed by a UE as described with reference to FIG. 9.

At 1204, the method may include transmitting the frame, where the frame includes, in a CP duration for each symbol a CP including at least one known sequence. The operations of 1204 may be performed in accordance with examples as described herein. In some implementations, aspects of the operations of 1204 may be performed by a UE as described with reference to FIG. 9.

It should be noted that the method described herein describes a possible implementation, and that the operations and the steps may be rearranged or otherwise modified and that other implementations are possible.

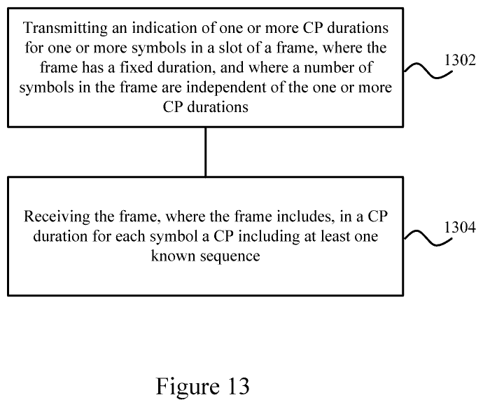

FIG. 13 illustrates a flowchart of a method in accordance with aspects of the present disclosure. The operations of the method may be implemented by an NE as described herein. In some implementations, the NE may execute a set of instructions to control the function elements of the NE to perform the described functions.

At 1302, the method may include transmitting an indication of one or more CP durations for one or more symbols in a slot of a frame, where the frame has a fixed duration, and where a number of symbols in the frame are independent of the one or more CP durations. The operations of 1302 may be performed in accordance with examples as described herein. In some implementations, aspects of the operations of 1302 may be performed by an NE as described with reference to FIG. 11.

At 1304, the method may include receiving the frame, where the frame includes, in a CP duration for each symbol a CP including at least one known sequence. The operations of 1304 may be performed in accordance with examples as described herein. In some implementations, aspects of the operations of 1304 may be performed by an NE as described with reference to FIG. 11.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive an indication of one or more cyclic prefix (CP) durations for one or more symbols in a slot of a frame, wherein the frame has a fixed duration, and wherein a number of symbols in the frame are independent of the one or more CP durations; and
transmit the frame, wherein the frame includes, in a CP duration for each symbol a CP comprising at least one known sequence.

2. The UE of claim 1, wherein each symbol in the frame comprises an orthogonal frequency-division multiplexing (OFDM) symbol, and wherein for each OFDM symbol, the CP duration comprises part of an inverse Fourier transform (IFFT) duration of the OFDM symbol.

3. The UE of claim 1, wherein the at least one processor is further operable to cause the UE to use a same CP duration for all of the symbols in the slot of the frame.

4. The UE of claim 1, wherein each symbol in the frame comprises an orthogonal frequency-division multiplexing (OFDM) symbol, and wherein the indication comprises a configuration that includes, for each OFDM symbol, an index for a code generator matrix that generates zeroes corresponding to the CP duration at an inverse Fourier transform (IFFT) output within a duration of the OFDM symbol.

5. The UE of claim 4, wherein a look-up table defines a one-to-one relationship of each of multiple code generator matrices to a CP duration or a known sequence length for a fast Fourier transform (FFT) length.

6. The UE of claim 5, wherein the configuration further includes an index that identifies a code generator matrix of the multiple code generator matrices and the known sequence length from the look-up table.

7. The UE of claim 1, wherein the at least one processor is further operable to cause the UE to:
receive a configuration that indicates to use different CP durations within a slot or across slots, wherein the configuration includes a set of indices for code generator matrices for each of the different CP durations;
apply a same code generator matrix for each symbol having a same CP duration;
generate the at least one known sequence that has a length corresponding to a largest CP duration; and
use the generated at least one known sequence inside each of the different CP durations.

8. The UE of claim 1, wherein each symbol in the frame comprises an orthogonal frequency-division multiplexing (OFDM) symbol, and wherein the at least one processor is further operable to cause the UE to:
receive an indication to use the at least one known sequence in the one or more CP durations for at least one of the OFDM symbols in a slot of a frame, wherein the at least one known sequence includes a first known sequence at an end of the OFDM symbol and a second known sequence at a start of the OFDM symbol, wherein the first known sequence and the second known sequence have a same length, wherein the first known sequence is part of an inverse Fourier transform (IFFT) interval, and wherein the second known sequence is added as an additional CP duration, and wherein the frame includes at least one symbol with the second known sequence added at the start of the OFDM symbol as a CP and the first known sequence added at the end of a duration of the OFDM symbol.

9. The UE of claim 8, wherein the first known sequence and the second known sequence are a same sequence with a same length.

10. The UE of claim 8, wherein the at least one processor is further operable to cause the UE to receive an indication of a position of symbols in the slot with second known sequence added at the start as the CP and the first known sequence added at the end of the duration of the OFDM symbol.

11. The UE of claim 8, wherein the at least one processor is further operable to cause the UE to use an identity matrix as a code generator matrix for symbols in the slot with random data as CP.

12. The UE of claim 1, wherein the at least one processor is further operable to cause the UE to:
receive a reporting configuration that includes an indication of a selection of a CP duration out of a set of configured CP durations based at least in part on propagating channel conditions; and
transmit a report that includes at least an indication of a length of the CP duration.

13. The UE of claim 12, wherein the report comprises a channel state information (CSI) report.

14. The UE of claim 13, wherein the report includes a field that indicates a length of the at least one known sequence.

15. The UE of claim 12, wherein the report includes an indication of an index derived from mapping of channel quality indicator (CQI) and the one or more CP durations to select a length of the at least one known sequence.

16. A network equipment (NE) for wireless communication, comprising:
at least one memory; and
at least one processor coupled with the at least one memory and operable to cause the NE to:
transmit an indication of one or more cyclic prefix (CP) durations for one or more symbols in a slot of a frame, wherein the frame has a fixed duration, and wherein a number of symbols in the frame are independent of the one or more CP durations; and
receive the frame, wherein the frame includes, in a CP duration for each symbol a CP comprising at least one known sequence.

17. The NE of claim 16, wherein each symbol in the frame comprises an orthogonal frequency-division multiplexing (OFDM) symbol, and wherein for each OFDM symbol, the CP duration comprises part of an inverse Fourier transform (IFFT) duration of the OFDM symbol.

18. The NE of claim 16, wherein a same CP duration is used for all of the symbols in the slot of the frame.

19. A method performed by a user equipment (UE), the method comprising:
receiving an indication of one or more cyclic prefix (CP) durations for one or more symbols in a slot of a frame, wherein the frame has a fixed duration, and wherein a number of symbols in the frame are independent of the one or more CP durations; and
transmitting the frame, wherein the frame includes, in a CP duration for each symbol a CP comprising at least one known sequence.

20. A method performed by a network equipment (NE), the method comprising:
transmitting an indication of one or more cyclic prefix (CP) durations for one or more symbols in a slot of a frame, wherein the frame has a fixed duration, and wherein a number of symbols in the frame are independent of the one or more CP durations; and
receiving the frame, wherein the frame includes, in a CP duration for each symbol a CP comprising at least one known sequence.
